(19) United States
(12) Patent Application Publication
(10) Pub. No.: US 2025/0356281 A1
(43) Pub. Date: Nov. 20, 2025

(54) CORRELATION OF LAB INSTRUMENT USAGE WITH LAB INSTRUMENT RESERVATIONS

(71) Applicant: Regeneron Pharmaceuticals, Inc., Tarrytown, NY (US)

(72) Inventors: Vinay Desai, Tarrytown, NY (US); John McLoughlin, Tarrytown, NY (US); Cristian Pelle, Tarrytown, NY (US); Michael Georgiadis, Tarrytown, NY (US)

(21) Appl. No.: 19/178,052

(22) Filed: Apr. 14, 2025

Related U.S. Application Data
(60) Provisional application No. 63/633,628, filed on Apr. 12, 2024.

(51) Int. Cl. G06Q 10/0631; G16Y 20/20; G16Y 40/20

(52) U.S. Cl. CPC G06Q 10/06312; G16Y 20/20; G16Y 40/20

(57) ABSTRACT

Systems, methods, and computer-readable media for managing reservations and usage of laboratory equipment are disclosed. In an aspect, a method for managing reservations of laboratory equipment includes receiving a request to reserve the first instrument device from a first user. The method further includes receiving instrument device data indicating first reservation data, first usage data, second reservation data, and second usage data. The first reservation data indicates at least one reservation and usage data by the first user; the second reservation data indicates at least one reservation and second usage data by a second user. The method further includes controlling a functionality of the first instrument device based on a comparison of the first reservation data with at least one of the first usage data and the second usage data.

### CROSS-REFERENCE TO RELATED APPLICATION(S)

This application claims the priority benefit, under 35 U.S.C. 119(e), of U.S. Application No. 63/633,628, filed Apr. 12, 2024, which is incorporated herein by reference in its entirety for all purposes.

### BACKGROUND

Collecting and analyzing utilization data from a multitude of instrument devices within a laboratory setting may present issues related to scalability and efficiency of use due to instrument devices each having their own proprietary data formats, functionalities, and use schedules. Scientific experiments, particularly in fields such as biotech, may utilize several different instrument devices at irregular time intervals, making coordination and planning difficult and prone to disruption from user error or instrument device malfunction. These disruptions may impede experimental data collection or scientific studies, and in serious cases may even render results unusable.

Further, these instrument devices may be expensive to buy and operate, and periods of inoperation may negatively impact their associated return on investment. A given laboratory setting may include instrument devices from multiple manufacturers, and coordinating device availability and use status in such a differentiated device setting has no readily available solution.

### SUMMARY

An instrument device may host or execute one or more instrument applications configured for transferring input data collected during studies, process-oriented workflows, and/or experiments to a monitoring and analytics system. However, the format of such input data may be proprietary for that particular instrument device and therefore less beneficial in an environment (e.g., laboratory) where various types of instrument devices are used. To resolve the issues inherent in managing a multitude of instrument devices and proprietary data formats, utilization data associated with support devices that operate and control the instrument devices may be used as a proxy to determine current or historical use of the instrument devices.

Additional advantages of the disclosed method and compositions will be set forth in part in the description which follows, and in part will be understood from the description, or may be learned by practice of the disclosed method and compositions. The advantages of the disclosed method and compositions will be realized and attained by means of the elements and combinations particularly pointed out in the appended claims. It is to be understood that both the foregoing general description and the following detailed description are exemplary and explanatory only and are not restrictive of the invention as claimed.

In some aspects, the techniques described herein relate to a method, including: receiving, from a plurality of support devices, utilization data for each support device of the plurality of support devices, the plurality of support devices being communicably coupled to a plurality of instrument devices, wherein the utilization data is associated with execution of at least one instrument application on each instrument device of the plurality of instrument devices, and wherein each support device controls the instrument device to which that support device is communicably coupled via the at least one instrument application executing on that instrument device; generating, based on the utilization data for each support device of the plurality of support devices, and based on a database schema associated with the plurality of instrument devices, a modified database schema including a plurality of fields to facilitate querying the utilization data associated with a specific instrument device of the plurality of instrument devices; generating, based on the modified database schema and the utilization data for each support device of the plurality of support devices, structured utilization data for each support device of the plurality of support devices, wherein the structured utilization data includes the plurality of fields; determining, based on at least one query associated with the structured utilization data for each support device of the plurality of support devices, a utilization rate for each instrument device of the plurality of instrument devices, wherein the at least one query is associated with at least one field of the plurality of fields; and outputting, via a graphical user interface, an indication of the utilization rate for each instrument device of the plurality of instrument devices.

In some aspects, the techniques described herein relate to a method including: receiving, via a plurality of support devices, a plurality of log files associated with a plurality of instrument devices, the plurality of instrument devices each executing at least one instrument application, wherein each support device of the plurality of support devices is communicably coupled to at least one instrument device of the plurality of instrument devices, and wherein each support device controls the at least one instrument device to which that support device is communicably coupled via the at least one instrument application executing on that instrument device; determining, based on the plurality of log files, a plurality of instrument-specific utilization metrics for each instrument device of the plurality of instrument devices; determining, based on the plurality of instrument-specific utilization metrics for each instrument device of the plurality of instrument devices, a health indicator for each instrument device of the plurality of instrument devices, wherein the health indicator is indicative of an availability of the corresponding instrument device; and outputting, via a graphical user interface, the health indicator for each instrument device of the plurality of instrument devices.

In some aspects, the techniques described herein relate to a system for managing access to a first instrument device, the system including: a plurality of support devices, each support device of the plurality of support devices communicatively coupled to a corresponding instrument device of a plurality of instrument devices; a processor; and a memory, the memory containing instructions thereon configuring the processor to: receive, from the plurality of support devices, utilization data for each support device of the plurality of support devices and each instrument device of the plurality of instrument devices, wherein the utilization data is associated with execution of at least one instrument application on each instrument device of the plurality of instrument devices, and wherein each support device controls operation of the instrument device to which that support device is communicably coupled via the at least one instrument application executing on that instrument device; receive, from each support device, scheduling information and operational information for the instrument device communicatively coupled to that support device, the operational information indicating whether that instrument device is available for use, reserved and in use, reserved but not in use, in use but not reserved, or unavailable for use; generate structured utilization data for each support device of the plurality of support devices and each instrument device of the plurality of instrument devices, wherein the structured utilization data includes a plurality of fields; and compare the at least one of the utilization data or the structured utilization data for each instrument device to its corresponding operational information over a predetermined time period or a predetermined time duration to classify usage of that instrument device as underused, overused, or normal.

In some aspects, the techniques described herein relate to a method for managing access to a first instrument device, the method including: receiving, from a first user, a request to reserve the first instrument device; receiving instrument device data indicating first reservation data, first usage data, second reservation data, and second usage data, wherein: the first reservation data indicates at least one reservation by the first user; the first usage data indicates a usage of the first instrument device by the first user during the at least one reservation by the first user; the second reservation data indicates at least one reservation by a second user; the second usage data indicates a usage of the first instrument device by the second user during the at least one reservation by the second user; controlling a functionality of the first instrument device based on a comparison of the first reservation data with at least one of the first usage data and the second usage data.

In some aspects, the techniques described herein relate to a non-transitory computer readable medium having instructions stored thereon, the instructions configuring a processor to perform a method for managing access to a first instrument device, the method including: receiving, from a first user, a request to reserve the first instrument device; receiving, from the first instrument device, instrument device data indicating first reservation data, first usage data, second reservation data, and second usage data, wherein: the first reservation data indicates at least one reservation by the first user; the first usage data indicates a usage of the first instrument device by the first user during the at least one reservation by the first user; the second reservation data indicates at least one reservation by a second user; the second usage data indicates a usage of the first instrument device by the second user during the at least one reservation by the second user; controlling a functionality of the first instrument device based on a comparison of the first reservation data with at least one of the first usage data and the second usage data.

All combinations of the foregoing concepts and additional concepts discussed in greater detail below (provided such concepts are not mutually inconsistent) are part of the inventive subject matter disclosed herein. In particular, all combinations of claimed subject matter appearing at the end of this disclosure are part of the inventive subject matter disclosed herein. The terminology used herein that also may appear in any disclosure incorporated by reference should be accorded a meaning most consistent with the particular concepts disclosed herein.

### BRIEF DESCRIPTION OF THE DRAWINGS

The skilled artisan will understand that the drawings primarily are for illustrative purposes and are not intended to limit the scope of the inventive subject matter described herein. The drawings are not necessarily to scale; in some instances, various aspects of the inventive subject matter disclosed herein may be shown exaggerated or enlarged in the drawings to facilitate an understanding of different features. In the drawings, like reference characters generally refer to like features (e.g., functionally similar and/or structurally similar elements).

The accompanying drawings, which are incorporated in and constitute a part of this specification, illustrate several embodiments of the disclosed method and compositions and together with the description, serve to explain the principles of the disclosed methods and systems:

FIG. 1 shows an example system.

FIG. 2 shows example raw utilization data;

FIG. 3 shows an example graph.

FIG. 4 shows example elements of a database schema.

FIG. 5 shows an example query.

FIG. 6 shows an example query.

FIG. 7 shows an example query and query results.

FIG. 8 shows an example table of asset/instrument data.

FIG. 9 shows an example database schema.

FIG. 10 shows an example dashboard interface.

FIG. 11 shows portions of an example verbose log file.

FIG. 12 shows portions of an example query result.

FIG. 13 shows an example dashboard interface.

FIG. 14 shows an example dashboard interface.

FIG. 15 shows an example system.

FIG. 16 shows a flowchart for an example method.

FIG. 17 shows a flowchart for an example method.

FIG. 18 shows various scenarios of instrument reservation vs. actual use.

FIG. 19 shows a flowchart for an example method.

### DETAILED DESCRIPTION

The disclosed methods and systems may be understood more readily by reference to the following detailed description of particular embodiments and the Example included therein and to the Figures and their previous and following description.

It is understood that the disclosed method and systems are not limited to the particular methodology, protocols, and reagents described as these may vary. It is also to be understood that the terminology used herein is for the purpose of describing particular embodiments only, and is not intended to limit the scope of the present invention which will be limited only by the appended claims.

It must be noted that as used herein and in the appended claims, the singular forms “a.”, “an.” and “the” include plural reference unless the context clearly dictates otherwise. Thus, for example, reference to “an image” includes a plurality of images, and so forth.

“Optional” or “optionally” means that the subsequently described event, circumstance, or material may or may not occur or be present, and that the description includes instances where the event, circumstance, or material occurs or is present and instances where it does not occur or is not present.

Throughout the description and claims of this specification, the word “comprise” and variations of the word, such as “comprising” and “comprises,” means “including but not limited to,” and is not intended to exclude, for example, other additives, components, integers or steps. In particular, in methods stated as comprising one or more steps or operations it is specifically contemplated that each step comprises what is listed (unless that step includes a limiting term such as “consisting of”), meaning that each step is not intended to exclude, for example, other additives, components, integers or steps that are not listed in the step.

“Exemplary” means “an example of” and is not intended to convey an indication of a preferred or ideal configuration. “Such as” is not used in a restrictive sense, but for explanatory purposes.

Ranges may be expressed herein as from “about” one particular value, and/or to “about” another particular value. When such a range is expressed, also specifically contemplated and considered disclosed is the range, from the one particular value and/or to the other particular value unless the context specifically indicates otherwise. Similarly, when values are expressed as approximations, by use of the antecedent “about,” it will be understood that the particular value forms another, specifically contemplated embodiment that should be considered disclosed unless the context specifically indicates otherwise. It will be further understood that the endpoints of each of the ranges are significant both in relation to the other endpoint, and independently of the other endpoint unless the context specifically indicates otherwise. Finally, it should be understood that all of the individual values and sub-ranges of values contained within an explicitly disclosed range are also specifically contemplated and should be considered disclosed unless the context specifically indicates otherwise. The foregoing applies regardless of whether in particular cases some or all of these embodiments are explicitly disclosed.

Described herein are methods, systems, and apparatuses for improved instrument monitoring and analytics. An instrument device may host or execute one or more instrument applications configured for transferring “input data” collected or generated during studies, process-oriented workflows, and/or experiments, which may be stored at a monitoring and analytics system (e.g., via a support device). Each support device may comprise one or more support device applications configured for controlling/operating the instrument device(s) in communication with that particular support device via the one or more instrument applications. A support device application may generate and/or collect various types of “performance data” during operation. The performance data may be associated with the support device's control/operation of the corresponding instrument device(s) via the one or more support device applications and the one or more instrument applications. The performance data may also be associated with the support device receiving, processing, and/or sending the input data (e.g., for storage of the input data). Such performance data is referred to herein as “raw utilization data” or simply “utilization data,” which may be indicative of an amount of resources the corresponding support device is using at a specific time and/or over a configurable period of time. The instrument devices may be capable of transferring input data that relates to an experiment or study to a corresponding support device; however, the instrument devices may not be capable of (or configured for) sending the input data in a manner that would indicate their current or historical utilization rate/activity. For example, for some instrument devices, the corresponding one or more instrument applications may be capable of collecting and/or generating a form of utilization data, but the format of such data may be proprietary for that particular instrument device and therefore less beneficial in an environment (e.g., laboratory) where various types of instrument devices are used.

To resolve the issues inherent in managing a multitude of instrument devices and proprietary data formats, the raw utilization data associated with the support devices may be used as a proxy to determine current or historical utilization rates/activity levels for the various instrument devices. For example, when an instrument device sends input data to a corresponding support device (e.g., experiment-related data), as well as when the support device controls/operates the instrument device, the corresponding raw utilization data may indicate a level of processor(s) use, memory use, etc., for the support device that serves as a proxy or heuristic for utilization of the instrument device.

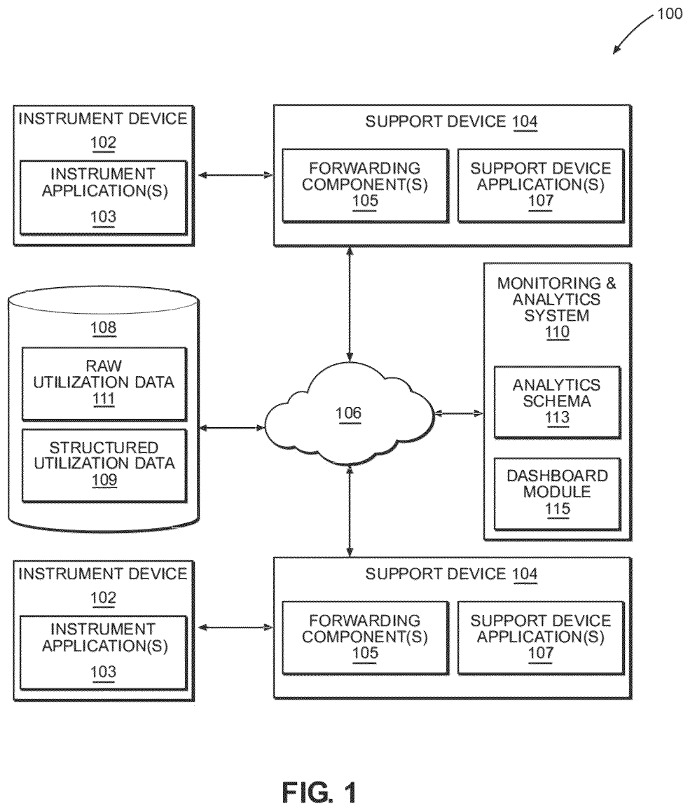

FIG. 1 shows an example system 100 for improved instrument monitoring and analytics. Those skilled in the art would understand that FIG. 1 represents one example of a system and is not meant to be limiting. The system 100 may comprise one or more support devices 104 that are in communication with one or more instrument devices 102. An instrument device 102 may include, but is not limited to, any one of a variety of laboratory instruments or equipment, such as a microscope, flow cytometer, spectrometer, scanner, protein analyzer, etc. A support device 104 may comprise a computing device, such as a laptop, desktop, tablet, mobile device, etc. An instrument device may perform any suitable operation/set of operations including, but not limited to, one or more biological operations (e.g., fermentation, cell culture, etc.), chemical operations (e.g., purification, crystallization, etc.), physical operations (e.g., thermal, acoustic, mechanical, electrical, magnetic, electromagnetic, optical, fluidic, etc.) such as increasing or decreasing a temperature of an object, moving (e.g., spinning, lifting, shaking, rotating, tilting, stretching, compressing, or any suitable movement) an object, applying a voltage to an object, applying a current to an object, emitting electromagnetic radiation at an object, defining or setting a frequency of an object, or any suitable physical operation. The one or more operations may correspond to an experiment or a portion of an experiment, such as a scientific experiment, an in vivo animal experiment, a biological experiment, an in vitro experiment, or any suitable experiment.

A support device 104 may include a computing device, such as a laptop, desktop, tablet, mobile device, etc. A support device 104 and an instrument device 102 may be in communication by wired or wireless means. A support devices 104, which is capable of network communications, may function as a bridge between a corresponding instrument device 102 and a monitoring and analytics system 110. Support devices 104 may be in communication with the monitoring and analytics system 110 via a network 106. The network 106 may include, for example, one or more LANs, WANs, cellular networks (e.g., LTE, HSPA, 3G, and other cellular technologies), and/or networks using any of wired, wireless, terrestrial, microwave, or satellite links, and may include the Internet.

An instrument device 102 may host or execute one or more instrument applications 103 configured for transferring “input data” collected or generated during studies, process-oriented workflows, and/or experiments to the monitoring and analytics system 110 via a support device 104. Each support device 104 may include one or more support device applications 107 configured for controlling/operating the instrument device(s) 102 in communication with that particular support device 102 via the one or more instrument applications 103. A support device application 107 may generate and/or collect various types of “performance data” during operation of the corresponding support device 104, such as events, logs, network data, sensor data, and/or other types of machine-generated data. The performance data may be associated with the support device's 104 control/operation of the corresponding instrument device(s) 102 via the one or more support device applications 107 and the one or more instrument applications 103. The performance data may also be associated with the support device 104 receiving, processing, and/or sending the input data (e.g., for storage of the input data at the monitoring and analytics system 110). Such performance data is referred to herein as “raw utilization data,” or simply “utilization data” (e.g., machine-generated raw data, Windows Management Instrumentation™ events or logs, etc.). For example, the raw utilization data 111 may be indicative of an amount of resources the corresponding support device 104 is using at a specific time and/or over a configurable period of time, such as processor(s) use, non-volatile memory use (e.g., read-only memory), volatile memory use (e.g., random access memory (RAM)), storage device(s) use (e.g., capacity, size, etc.), a combination thereof, and/or the like.

The instrument devices 102 may be capable of transferring input data that relates to an experiment or study to a corresponding support device 104; however, the instrument devices 102 may not be capable of (or configured for) sending the input data in a manner that would indicate their current or historical utilization rate/activity. For example, for some instrument devices 102, the corresponding instrument application 103 may be capable of collecting and/or generating a form of utilization data, but the format of such data may be proprietary for that particular instrument device 102 and therefore less beneficial in an environment (e.g., laboratory) where various types of instrument devices 102 are used. To resolve the issues inherent in managing a multitude of instrument devices 102 and proprietary data formats, the raw utilization data 111 associated with the support devices 104 may be used as a proxy to determine current or historical utilization rates/activity levels for the various instrument devices 102. For example, when an instrument device 102 sends input data to a corresponding support device 104 (e.g., experiment-related data via an instrument application 103), the corresponding raw utilization data 111 may indicate a level of processor(s) use, memory use, etc., for the support device 104 that serves as a proxy or heuristic for utilization of the corresponding instrument device 102.

Raw utilization data 111 associated with one or more of the instrument devices 102 may be sent by the support devices 104, via the network 106, to a database 108. The database 108 may include configuration files/information for the instrument devices 102 and/or the support devices 104. The database 108 may receive raw utilization data 111 associated with an instrument device 102 and generate (e.g., via a server(s)—not shown) structured utilization data 109. The structured utilization data 109 for a particular support device 104 may be based on the raw utilization data 111 corresponding to that support device 104. The structured utilization data 109 may include aspects or portions of the raw utilization data 111, except the structured utilization data 109 may have a higher degree of organization according to a database schema. The structured utilization data 109 may be appended to a relational database(s) within the database 108 according to the database schema to enable querying of the structured utilization data 109 via the monitoring and analytics system 110, which is further discussed herein.

The support devices 104 may each include a forwarding component 105. The forwarding component 105 may include software or other logic that facilitates sending the raw utilization data 111 for a corresponding support device 104 to the database 108 and/or to the monitoring and analytics system 110. For example, as described herein, the support device application 107 may generate and/or collect the raw utilization data 111″ (e.g., machine-generated raw data) for the corresponding support device 104 (e.g., processor(s) use, memory use, etc.), and the forwarding component 105 may be responsible for sending that raw utilization data 111 to the database 108 and/or to the monitoring and analytics system 110 via the network 106. In some examples, the forwarding component 105 for a particular support device 104 may collect instrument-specific information corresponding to the instrument device 102. Such instrument-specific information may include, for example, an identifier(s) for the instrument device 102, a type of the instrument device 102, a manufacturer and/or model of the instrument device 102, a version(s) of the instrument application 103, information related to an operating system for the instrument device 102, etc. In some examples, the forwarding component 105 may collect support device-specific information corresponding to the particular support device 104. Such support device-specific information may include, for example, an identifier(s) for the support device 104, a type of the support device 104, a manufacturer and/or model of the support device 104, a version(s) of the support application 104, information related to an operating system for the support device 104, etc.

As shown in FIG. 1, the forwarding component 105 is separate from the support device application 107. However, in some configurations of the system 100, the forwarding component 105 may be a component of the support device application 107, a plug-in, an extension, or any other type of add-on component. The forwarding component 105 may include, in some examples, a universal forwarder (e.g., a Splunk™ universal forwarder). The universal forwarder may be cross-compatible with various types of hardware, operating systems, etc. The universal forwarder may be an executable (e.g., a software instance) on the support device 104. The universal forwarder may collect and forward (e.g., send) the raw utilization data 111 (e.g., machine-generated raw data) to the monitoring and analytics system 110 and/or the database 108. As described herein, the database 108 may receive raw utilization data 111 associated with an instrument device 102 and generate structured utilization data 109 based on the raw utilization data 111 corresponding to that support device 104. In some examples, the forwarding component 105 may generate (e.g., via the universal forwarder) the structured utilization data 109 based on the raw utilization data 111.

The forwarding components 105 of the supporting devices 104 may facilitate improved methods for collecting and analyzing instrument-related data or information and support device-related data or information. For example, as noted herein, collecting and analyzing data from a multitude of instrument devices 102 may present issues related to scalability of the monitoring and analytics system 110 due to the instrument devices 102 each having their own proprietary data format (e.g., vendor-specific formats). Using the raw utilization data 111 and the corresponding structured utilization data 109 as a proxy for instrument utilization, the monitoring and analytics system 110 may circumvent computational, and possibly fiscal, ramifications of relying solely on instrument-specific utilization data. The monitoring and analytics system 110 may thus be considered “instrument agnostic” in the sense that utilization of the instrument devices 102, regardless of type/manufacturer, may be determined.

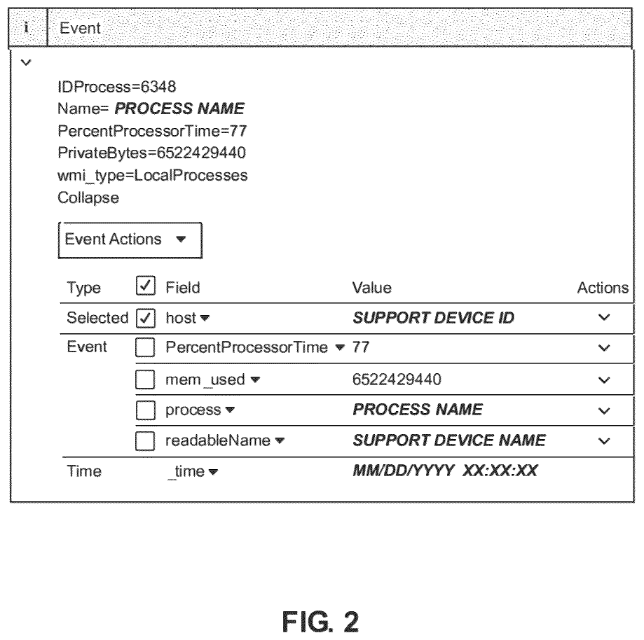

FIG. 2 shows example raw utilization data 111 for an example support device 104. The example raw utilization data 111 shown in FIG. 2 may correspond to a time, or range or time, during which the example support device 104 was receiving and/or processing input data collected during studies, process-oriented workflows, and/or experiments by the corresponding instrument device 102. As can be seen in FIG. 2, the raw utilization data 111 for the example support device 104 includes a variety of information. Some of that information (e.g., portions of the raw utilization data 111) may be used as a proxy for instrument utilization for the corresponding instrument device 102.

For example, the field “PercentProcessorTime” may indicate an amount of processor(s) usage for the example support device 104. As another example, the field “mem_used” may indicate an amount of memory (e.g., RAM) usage for the example support device 104. The example raw utilization data 111 shown in FIG. 2 may identify the example support device 104 by one or more fields, such as the “host” field and the “readableName” field. The example raw utilization data 111 shown in FIG. 2 may also identify a process(es) that resulted in the raw utilization data 111 (e.g., an event name) using the “process” field. The raw utilization data 111 shown in FIG. 2 may also identify a time that corresponds to the process(es) that resulted in the raw utilization data 111 using the “_time” field (e.g., a timestamp). The format of the raw utilization data 111 shown in FIG. 2 is an example only and not meant to be restrictive. The support devices 104 may provide different formats of raw utilization data 111 that may be used by the monitoring and analytics system 110.

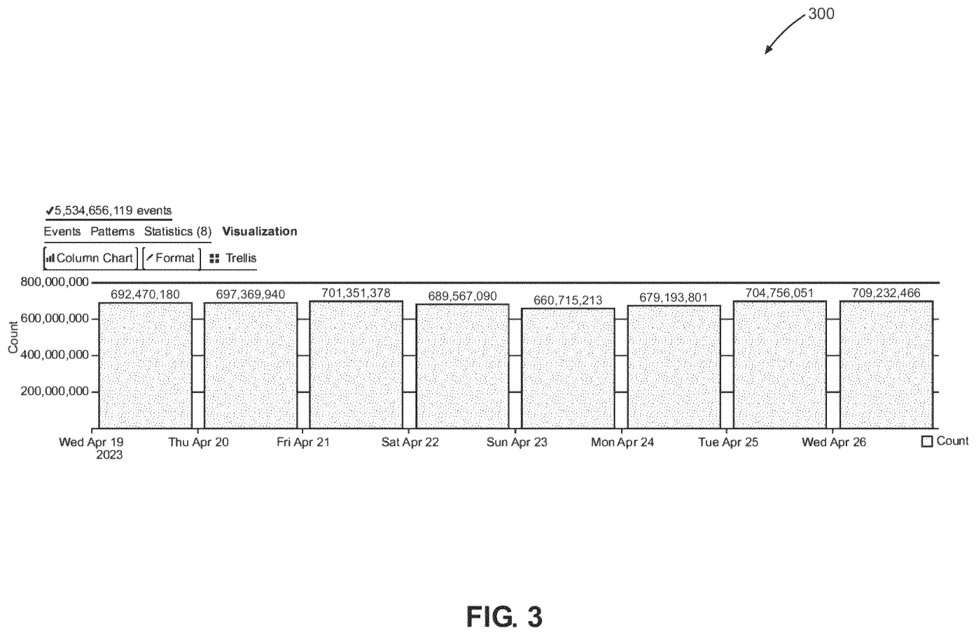

Each of the support devices 104 may send raw utilization data 111 for numerous events, processes, etc., related to the instrument devices 102 throughout a given period of time. For example, as shown in FIG. 3., raw utilization data 111 for nearly 680 million events/processes may be ingested by the monitoring and analytics system 110 in just one day.

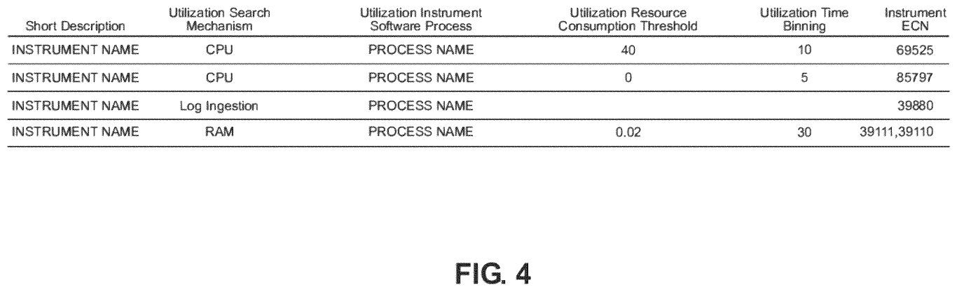

As described herein, the database 108 may receive raw utilization data 111 associated with an instrument device 102 and generate structured utilization data 109. FIG. 4 shows an example of such structured utilization data 109 for four example support devices 104 based on corresponding raw utilization data 111. As shown in FIG. 4, the structured utilization data 109 may include aspects or portions of raw utilization data 111 organized according to a database schema. To facilitate querying of the structured utilization data 109 via the monitoring and analytics system 110, the database 108 may be configured to organize the raw utilization data 111 into a plurality of fields, such as: “Name,” “Utilization Search Mechanism,” “Utilization Instrument Software Process,” “Utilization Resource Consumption Threshold,” “Utilization Time Binning,” and “Instrument ECN.” The “Name” field in the structured utilization data 109 may correspond to the “host” field shown in the raw utilization data 111 in FIG. 2. The “Instrument ECN” field in the structured utilization data 109 may be an identifier for the particular instrument device 102 corresponding to the support device 104.

The database 108 (or another device of the system 100—not shown) may be configured to modify a standard (or existing) format for configuration data so it may be used when generating the structured utilization data 109. For example, the structured utilization data 109 may be based on, or include, modified configuration data related to the support devices 104 and the instrument devices 102. The configuration data may correspond to a Configuration Management Database (“CMDB”) already existing in the database 108 (or another device of the system 100—not shown). The CMDB may store a catalog of information related to which particular instrument device 102 is in communication with a particular support device 104. Other information may be provided in the CMDB, and the fields within the CMDB may be modified to include the “Utilization Search Mechanism” field, the “Utilization Instrument Software Process” field, the “Utilization Resource Consumption Threshold” field, and the “Utilization Time Binning” field shown in FIG. 4. Those fields may be added to a database schema for the configuration data in the CMDB (the “CMDB schema”) to facilitate generation of the structured utilization data 109 as well as to facilitate queries performed by the monitoring and analytics system 110 as further described herein.

For example, the “Utilization Search Mechanism” field may be added to the CMDB schema so that the value for “PercentProcessorTime” and/or “mem_used” within the raw utilization data 111 for a particular support device 104 may be queried to determine processor usage and/or memory usage, respectively. As another example, the “Utilization Instrument Software Process” field may be added to the CMDB schema so that the value for the “process” field within the raw utilization data 111 for the particular support device 104 may be queried to determine the particular process(es) the support device 104 was executing/running that resulted in the raw utilization data 111 (e.g., an event(s) name). As a further example, the “Utilization Resource Consumption Threshold” field may be added to the CMDB schema so that the values for “PercentProcessorTime” and/or “mem_used” within the raw utilization data 111 for the support device 104 may be used as a filtering mechanism, depending on a corresponding value for each and a configurable threshold value for each as further described herein. The “Utilization Time Binning” field may be added to the CMDB schema so that the value for the “_time” field (e.g., a timestamp) within the raw utilization data 111 for the support device 104 may be used to bin/group the utilization data within a period(s) of time (e.g., to group the data within “bins” of time).

The monitoring and analytics system 110 may query the structured utilization data 109 and/or the raw utilization data 111 stored in the database 108. For example, the monitoring and analytics system 110 may query the structured utilization data 109 and/or the raw utilization data 111 stored in the database 108 according to the modified CMDB schema described herein (e.g., including the “Name,” “Utilization Search Mechanism,” “Utilization Instrument Software Process,” “Utilization Resource Consumption Threshold,” “Utilization Time Binning,” and/or “Instrument ECN” fields described herein). The monitoring and analytics system 110 may query the structured utilization data 109 and/or the raw utilization data 111 to determine a current or historical utilization rate for a particular instrument device 102/support device 104.

The queries may be configured to determine, among other things, (1) when the corresponding support device application 107 was executing on the corresponding support device 104 and (2) when the corresponding support device application 107 was actually consuming resources of the support device 104. By configuring the queries in this way, the monitoring and analytics system 110 may essentially filter-out false or misleading query results. For example, if the queries were not configured in this manner, a false or misleading query result may occur in situations where the support device 104 is powered on and running but the support device application 107 is not executing (e.g., the instrument device 102 is not being used). As another example, if the queries were not configured in this manner, a false or misleading query result may occur in situations where the support device 104 is powered on and running and the support device application 107 is executing but the instrument device 102 is idle.

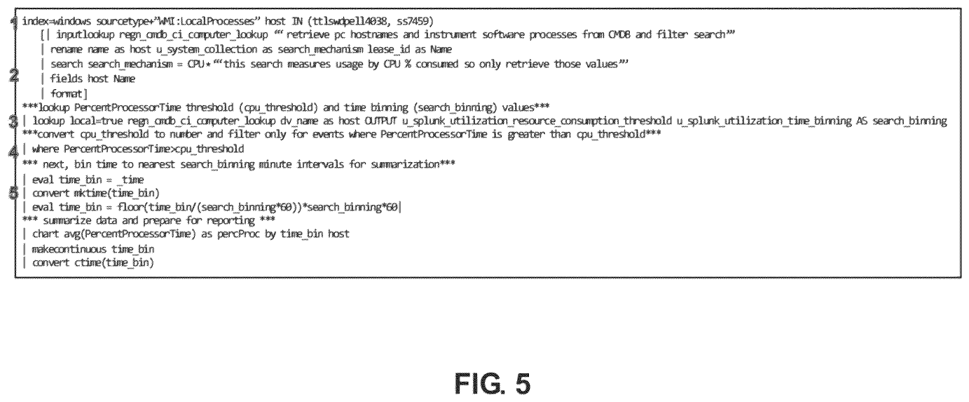

FIG. 5 shows another example of a Processor-based Utilization Query with annotations 1-5, which are included to describe various aspects/sub-queries of the Processor-based Utilization Query:
1. Query of the ingested raw utilization data 111;
2. Query of the structured utilization data 109, which is configured to return only the support devices 104 that have a search mechanism for a processor-related field (“PercentProcessorTime”) with a filter to return only the support device application 107 processes for those particular support devices 104;
3. Query of the structured utilization data 109 a second time to determine whether the “PercentProcessorTime” field meets or exceeds a configurable threshold value (“cpu_threshold”) within a time frame/bin/period (“time bin”);
4. Filter data where the configurable threshold value was not met or exceeded; and
5. Bin the results to a set time period.

The results of the example Processor-based Utilization Query identify when the support device application 107 (and/or the instrument application 103) was running/executing and when resources being used met or exceeded the configurable threshold value (e.g., the value assigned for “cpu_threshold”). The Processor-based Utilization Query has the ability to filter down to a specific process of the support device application 107 for a specific support device 104 with a configurable threshold value for processor usage and as well as a time bin. The configurable threshold value for the Processor-based Utilization Query may be set, for example as shown in FIG. 4, at “40” to account for an amount/portion of processor(s) resources that the particular support device 104 may consume when idle and/or when processing data unrelated to an experiment or study (e.g., performing a system or software update, etc.). That is, the configurable threshold value for the Processor-based Utilization Query may function as a filter so that processor usage below the configurable threshold value is not returned as a result of the query.

As can be seen from FIG. 5, the Processor-based Utilization Query retrieves a value for comparing against the configurable threshold value using the “PercentProcessorTime” field, which may be retrieved from the corresponding raw utilization data 111 described herein. As can also be seen from FIG. 5, the time bin value may be retrieved from the raw utilization data 111 using the “_time” field (e.g., a timestamp). Using reference values rather than hardcoded values for these portions of the Processor-based Utilization Query may have significant scaling and support benefits. For example, instead of creating a unique query for each process, the monitoring and analytics system 110 may use more widely-applicable queries that function across nearly all software and hardware types—so long as processor usage may be ascertained from the corresponding raw utilization data 111 and/or structured utilization data 109.

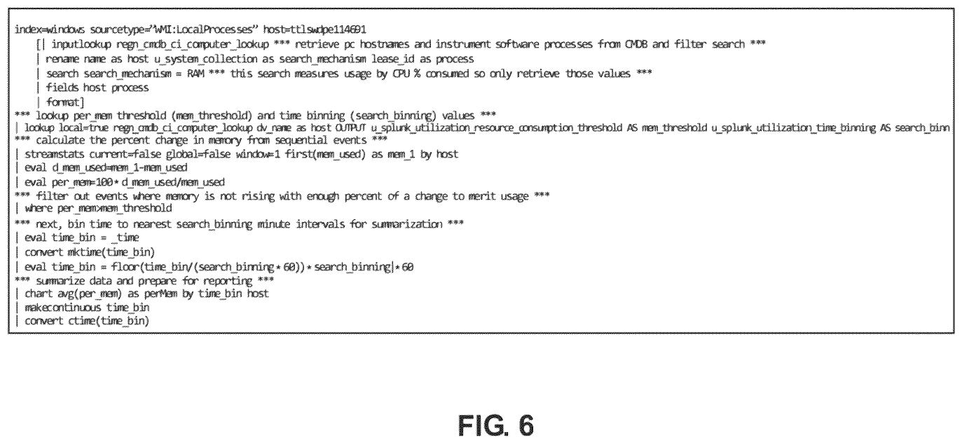

FIG. 6 shows an example query that is similar to the Processor-based Utilization Query, except that it provides results associated with memory usage of the support device 104, referred to herein as a “Memory-based Utilization Query.” The Memory-based Utilization Query may be used by the monitoring and analytics system 110 in situations where the Processor-based Utilization Query may not provide an accurate representation of actual usage of the instrument device 102 and/or the instrument application 103. For example, some processes of the instrument device 102 and/or the instrument application 103, as well as some versions/types of instrument devices 102 and/or the instrument application 103, consume very little processor resources such that the Processor-based Utilization Query may not provide an accurate representation of actual usage of the instrument device 102 and/or the instrument application 103.

As shown in FIG. 6, the Memory-based Utilization Query may share many key pieces with the Processor-based Utilization Query. However, rather than querying for memory usage above a configurable threshold (e.g., in contrast to the Processor-based Utilization Query's use of a processor usage threshold), the Memory-based Utilization Query may be configured to determine a rate of change for memory usage. For example, the rate of change for memory usage may be an indication of a percentage-based change of memory usage for the support device 104 between a first time and a second time (e.g., a rate of change during a configurable time period). The Memory-based Utilization Query may be configured to determine whether the rate of change for memory usage meets or exceeds a configurable threshold value for a result to be returned (e.g., for a result other than “null” to be returned). The Memory-based Utilization Query may use a “mem_threshold” field for the configurable threshold value, which is shown in FIG. 6. The Memory-based Utilization Query may also use the “mem_used” field described above, which may be retrieved from raw utilization data 111 as shown in FIG. 2, and compared against the value assigned to the configurable threshold value (e.g., the value for the “mem_threshold” field) to determine whether the rate of change for memory usage meets or exceeds the configurable threshold value. The configurable threshold value for the Memory-based Utilization Query may be set, for example as shown in FIG. 4, at “0.2” to account for an amount/portion of memory that the particular support device 104 may consume when idle and/or when processing data unrelated to an experiment or study (e.g., performing a system or software update, etc.). That is, the configurable threshold value for the Memory-based Utilization Query may function as a filter so that memory usage below the configurable threshold value is not returned as a result of the query.

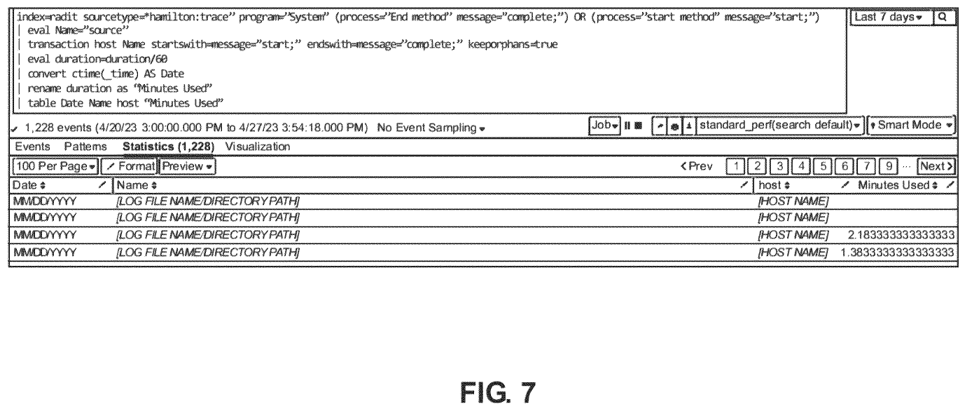

The monitoring and analytics system 110 may also use, in some examples, instrument-specific logs and/or instrument-management software information. For example, in situations where processor usage and/or memory usage of the support devices 104 is not available, the monitoring and analytics system 110 may use instrument-specific logs. Such instrument-specific logs may be used as a failover option. The instrument-specific logs may, as an example, be sent for storage in the database 108 (or another database(s)—not shown) by the instrument application 103 via the forwarding component 105. An example of an instrument-specific log is shown in FIG. 7.

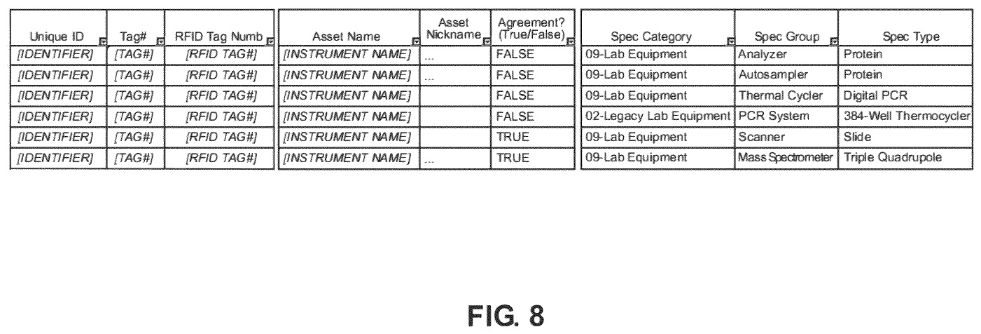

The instrument-management software information may be provided by a third-party Equipment asset management software suite, such as Tririga™. Each of the instrument devices 102 may be identified in the instrument-management software information using an Asset tag with a unique identifier number, as shown in FIG. 8. The monitoring and analytics system 110 may store the instrument-management software information in the database 108 (or another database(s)—not shown). The monitoring and analytics system 110 may identify which support device 104 is in communication with a particular instrument device 102 by matching the Asset tag/unique identifier number for the instrument device 102 with the value in the “Instrument ECN” field in the structured utilization data 109 for the instrument device 102. As shown in FIG. 8, the instrument-management software information may include a model of the corresponding instrument device 102 as well as a field called “spec group” that identifies the type of instrument device 102 (e.g., flow cytometer, mass spectrometer, etc.).

Returning briefly to FIG. 1, the monitoring and analytics system 110 may include an analytics schema 113 and a dashboard module 115. The analytics schema 113 may be based on and/or include the raw utilization data 111, the structured utilization data 109, the instrument-specific logs, and/or the instrument-management software information described herein. For example, the analytics schema 113 may be based on, or include, the modified CMDB schema described herein. A dashboard module 115 of the monitoring and analytics system 110, such as Microsoft Power BI™, may receive the raw utilization data 111, the structured utilization data 109, the instrument-specific logs, and/or the instrument-management software information via automated scripting software, such as Microsoft Power Automate Scripts™. For example, the automated scripting software may provide the aforementioned data and information to the dashboard module 115 via a series of messages, such as emails, API pulls, etc.

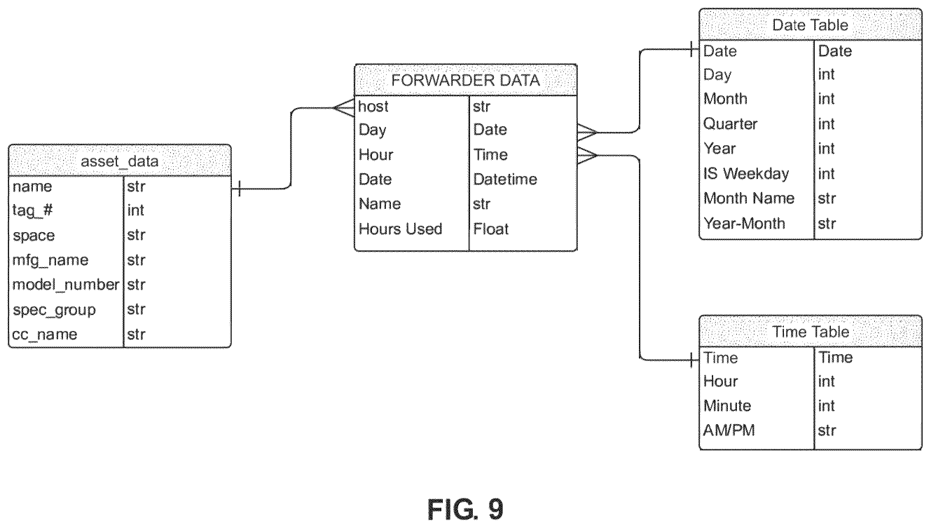

FIG. 9 shows an example of the analytics schema 113. The dashboard module 115 may retrieve the raw utilization data 111, the structured utilization data 109, the instrument-specific logs, and/or the instrument-management software information from the database 108 (and/or another database(s)—not shown) and generate the analytics schema 113. The dashboard module 115 may retrieve the underlying values for each item of the analytics schema 113 on a regular/scheduled basis (e.g., daily).

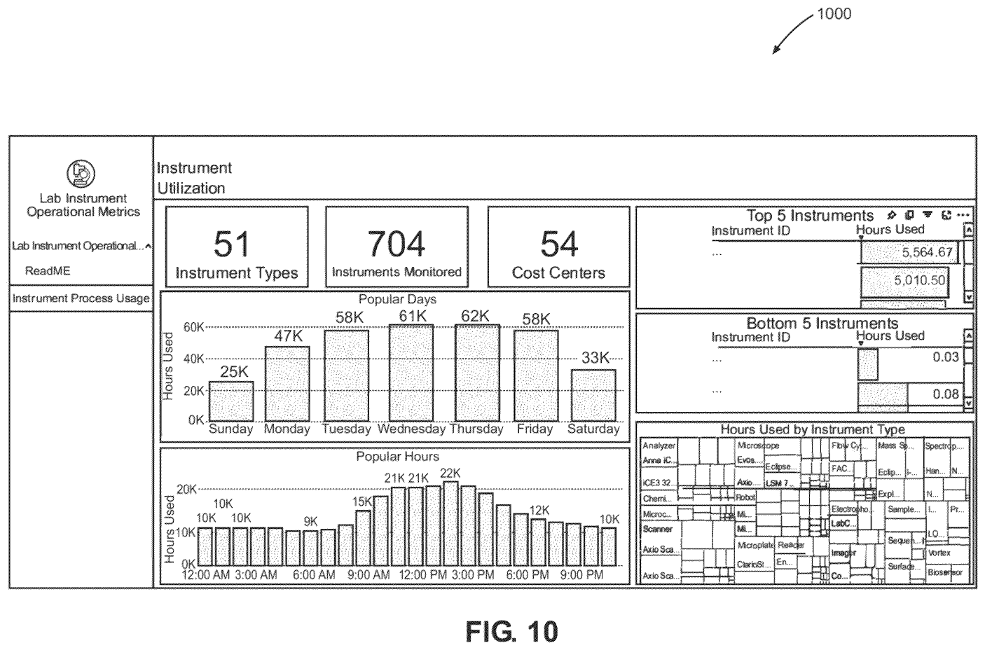

FIG. 10 shows an example dashboard (e.g., a user interface) as well as example visualizations that may be generated by the dashboard module 115 and output at one or more client devices in communication with the monitoring and analytics system 110 (e.g., computers, tablets, mobile devices, etc.).

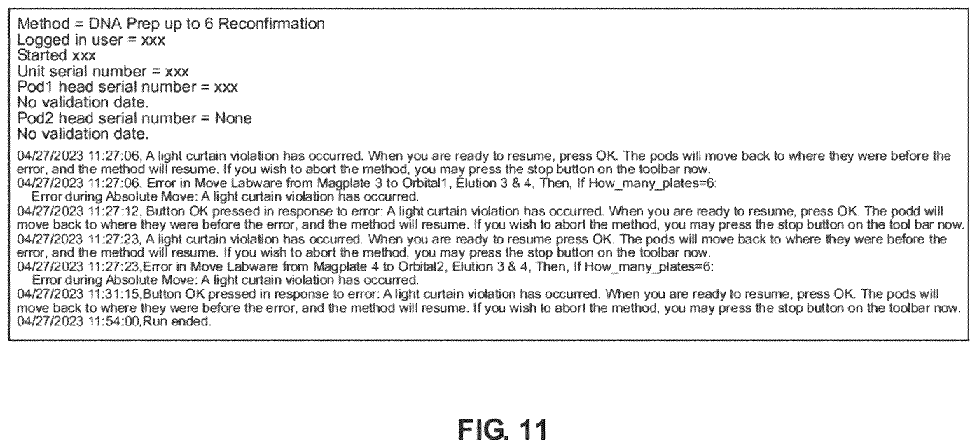

As described herein, the monitoring and analytics system 110 may use the raw utilization data 111 and the corresponding structured utilization data 109 associated with a particular instrument device 102 and/or a particular support device 104 as a proxy for instrument-specific utilization data. Such instrument-specific utilization data may be generated by the instrument application 103 of the particular instrument device 102 and/or by the support device application 107 of the particular support device 104. FIG. 11 shows an example of the instrument-specific utilization data, which may be output as one or more verbose logs.

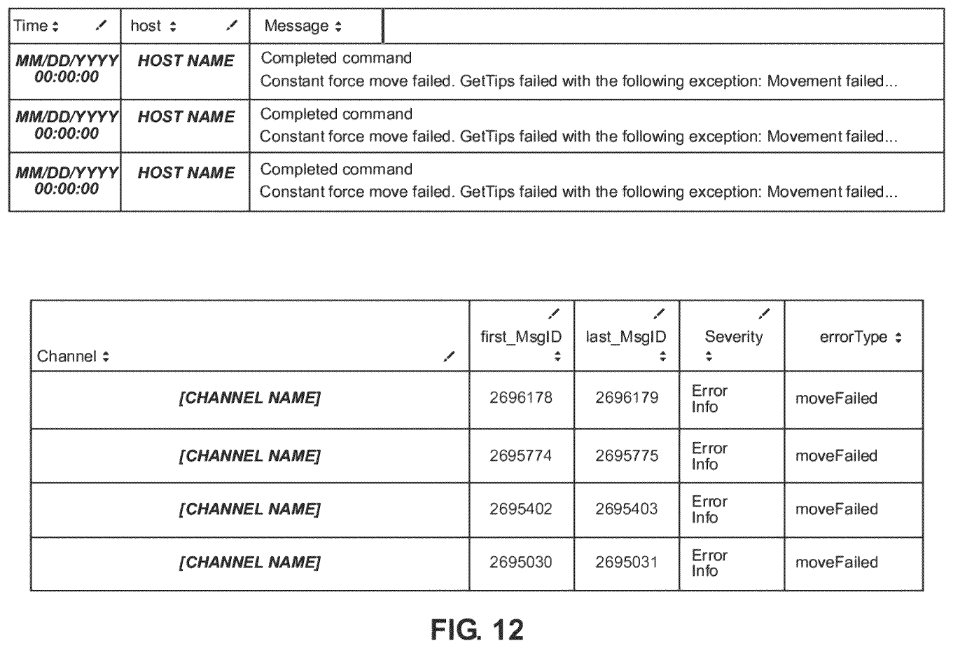

These verbose logs may contain, or be indicative of, several instrument-specific utilization metrics, such as when an instrument device 102 began and/or completed use (e.g., during an experiment or study), one or more warnings, errors, informational events, a combination thereof and/or the like. For example, FIG. 12 shows example results of a query of instrument-specific utilization data with instrument-specific filters. The particular instrument-specific filters may be dependent on the type, manufacturer, etc. of instrument device 102, a type of experiment or study being conducted, a type, developer, etc. of the instrument application 103, a combination thereof, and/or the like. The instrument-specific filters may be configured such that the query results only include relevant errors that may impact an availability of the particular instrument device 102. For example, as shown in FIG. 12, the results of querying the instrument-specific utilization data with instrument-specific filters may include a “host” field to identify the particular instrument device 102; an error “message” field to describe the error; an “errorType” to identify the type of error, etc.

As described herein, the raw utilization data 111 and the corresponding structured utilization data 109 associated with a particular instrument device 102 and/or a particular support device 104 may be used as a proxy for instrument-specific utilization data. However, using the raw utilization data 111 and the corresponding structured utilization data 109 as a proxy for instrument-specific utilization data may require deriving values for various metrics and elements that provide more information beyond identifying whether a particular instrument device 102 and/or support device 104 is “available,” “online,” etc. (e.g., available for use). A relative “health” or availability of the instrument devices 102 and/or support devices 104 may be easily determined using the instrument-specific utilization metrics within, or indicated by, the verbose logs/instrument-specific utilization data.

The instrument-specific utilization data for a particular instrument device 102 may be stored locally on the corresponding support device 104. The forwarding component 105 of the support device 104 may be configured (e.g., via the support device application 107) to send the instrument-specific utilization data (e.g., the verbose logs) to the database 108 and/or another database(s) (not shown). The instrument-specific utilization metrics described above may be extracted from the verbose logs and organized into fields that are easily readable and searchable by the monitoring and analytics system 110. The fields extracted from the verbose logs may be used to provide a “health dashboard” indicating the relative “health” or availability of instrument devices 102 and/or support devices 104.

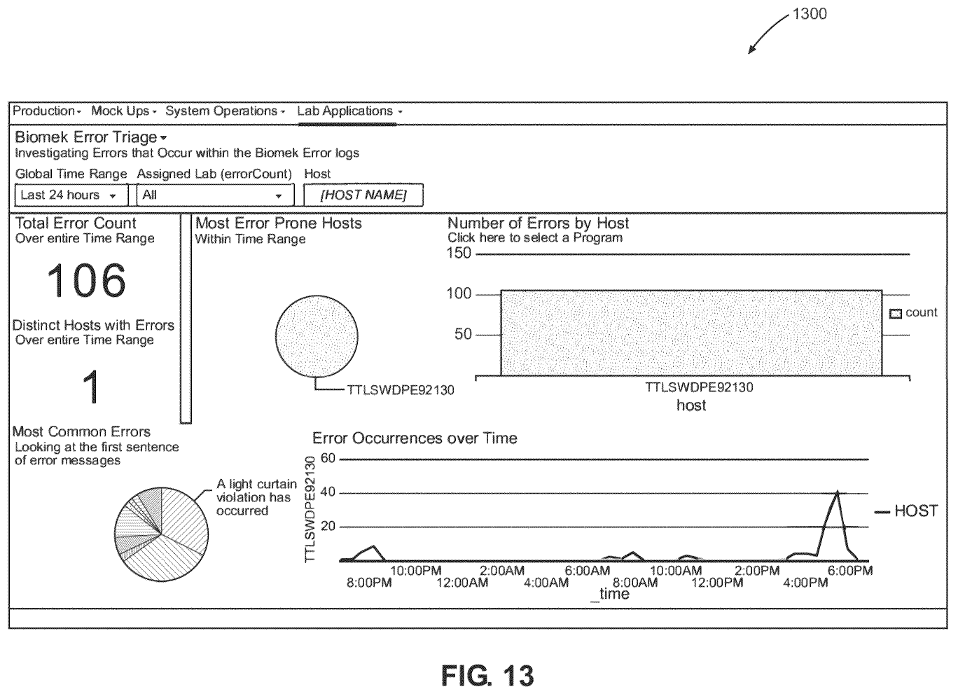

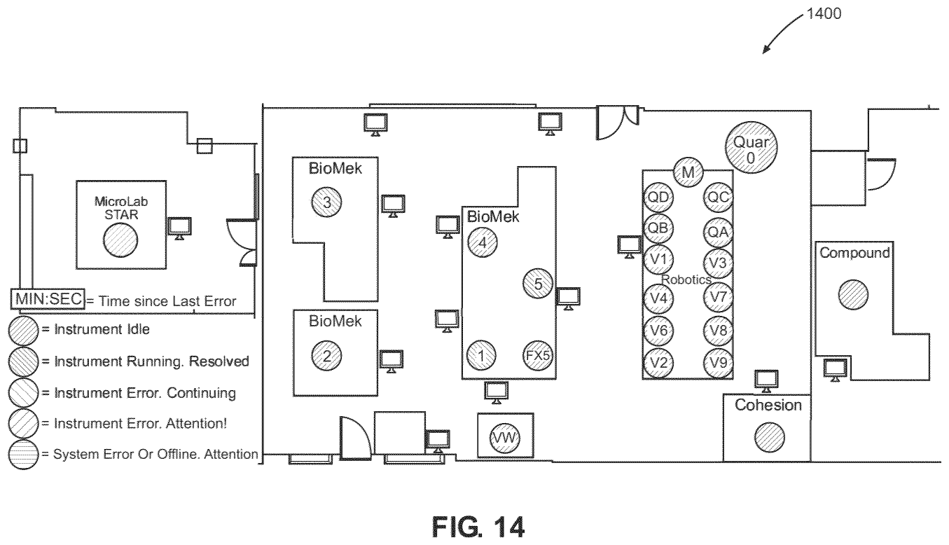

FIG. 13 shows an example health dashboard (e.g., a user interface) that the dashboard module 115 may output based on results of queries using the fields extracted from the verbose logs. FIG. 14 shows another example health dashboard with a map/diagram of example rooms (e.g., laboratory rooms) that may house one or more of the example instrument devices 102 and support devices 104 described herein. Each circle shown on the health dashboard in FIG. 14 may correspond to a support device 104 and/or an instrument device 102. The pattern or color of a particular circle may indicate a current status of the corresponding instrument device 102 for that support device 104, such as gray for idle; green for running; yellow for a less-than-critical instrument device 102 error, red for a critical instrument device 102 error, and purple for an offline or unavailable instrument device 102. FIG. 14 illustrates a patterns having stripes of different angles and densities to indicate instrument status. When a particular instrument device 102 is determined to be in an error state and/or otherwise not fully available for use, the monitoring and analytics system 110 may output a message via the health dashboard, which may be based on results of querying corresponding instrument-specific utilization data for a particular instrument device 102 using the instrument-specific filters described above.

The dashboard module 115 may query the verbose logs based on a timer, a schedule, a trigger based on a particular instrument-specific utilization metric, a combination thereof, and/or the like. Additionally, in some examples as shown in FIG. 14, a number may be included in the health dashboard proximate to each depicted support device 104 (e.g., within the circle) to indicate an amount of time (e.g., minutes, seconds, etc.) since the last error related to the corresponding instrument device 102 occurred. The number may be only visible when an error occurs and it may only be present until the error is cleared out, resolved, etc.

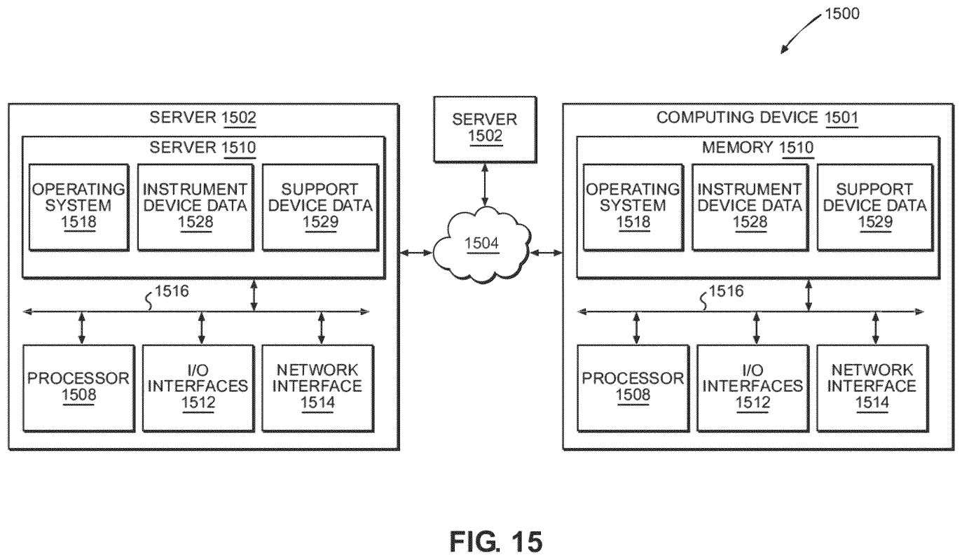

The present methods and systems may be computer-implemented. FIG. 15 shows a block diagram depicting a system/environment 1500 including non-limiting examples of a computing device 1501 and a server 1502 connected through a network 1504. Any of the entities or devices of the system 100 may be a computing device. In an aspect, some or all steps of any described method may be performed on a computing device as described herein. The computing device 1501 may include one or multiple computers configured to support device data 1529 and/or the like. The server 1502 may include one or multiple computers configured to store instrument device data 1528. Multiple servers 1502 may communicate with the computing device 1501 via the through the network 1504.

The computing device 1501 and the server 1502 may be a computer that, in terms of hardware architecture, generally includes a processor 1508, system memory 1510, input/output (I/O) interfaces 1512, and network interfaces 1514. These components (1508, 1510, 1512, and 1514) are communicatively coupled via a local interface 1516. The local interface 1516 may be, for example, but not limited to, one or more buses or other wired or wireless connections, as is known in the art. The local interface 1516 may have additional elements, which are omitted for simplicity, such as controllers, buffers (caches), drivers, repeaters, and receivers, to enable communications. Further, the local interface may include address, control, and/or data connections to enable appropriate communications among the aforementioned components.

The processor 1508 may be a hardware device for executing software, particularly that stored in system memory 1510. The processor 1508 may be any custom made or commercially available processor, a central processing unit (CPU), an auxiliary processor among several processors associated with the computing device 1501 and the server 1502, a semiconductor-based microprocessor (in the form of a microchip or chip set), or generally any device for executing software instructions. When the computing device 1501 and/or the server 1502 is in operation, the processor 1508 may execute software stored within the system memory 1510, to communicate data to and from the system memory 1510, and to generally control operations of the computing device 1501 and the server 1502 pursuant to the software.

The I/O interfaces 1512 may be used to receive user input from, and/or for providing system output to, one or more devices or components. User input may be provided via, for example, a keyboard and/or a mouse. System output may be provided via a display device and a printer (not shown). I/O interfaces 1512 may include, for example, a serial port, a parallel port, a Small Computer System Interface (SCSI), an infrared (IR) interface, a radio frequency (RF) interface, and/or a universal serial bus (USB) interface.

The network interface 1514 may be used to transmit and receive from the computing device 1501 and/or the server 1502 on the network 1504. The network interface 1514 may include, for example, a 10BaseT Ethernet Adaptor, a 10BaseT Ethernet Adaptor, a LAN PHY Ethernet Adaptor, a Token Ring Adaptor, a wireless network adapter (e.g., WiFi, cellular, satellite), or any other suitable network interface device. The network interface 1514 may include address, control, and/or data connections to enable appropriate communications on the network 1504.

The system memory 1510 may include any one or combination of volatile memory elements (e.g., random access memory (RAM, such as DRAM, SRAM, SDRAM, etc.)) and nonvolatile memory elements (e.g., ROM, hard drive, tape, CDROM, DVDROM, etc.). Moreover, the system memory 1510 may incorporate electronic, magnetic, optical, and/or other types of storage media. Note that the system memory 1510 may have a distributed architecture, where various components are situated remote from one another, but may be accessed by the processor 1508.

The software in system memory 1510 may include one or more software programs, each of which includes an ordered listing of executable instructions for implementing logical functions. In the example of FIG. 15, the software in the system memory 1510 of the computing device 1501 may include the support device data 1529, the instrument device data 1528, and a suitable operating system (O/S) 1518. In the example of FIG. 15, the software in the system memory 1510 of the server 1502 may include the support device data 1529, the instrument device data 1528, and a suitable operating system (O/S) 1518. The operating system 1518 essentially controls the execution of other computer programs and provides scheduling, input-output control, file and data management, memory management, and communication control and related services.

For purposes of illustration, application programs and other executable program components such as the operating system 1518 are shown herein as discrete blocks, although it is recognized that such programs and components may reside at various times in different storage components of the computing device 1501 and/or the server 1502. An implementation of the system/environment 1500 may be stored on or transmitted across some form of computer readable media, including non-transitory computer readable media. Any of the disclosed methods may be performed by computer readable instructions embodied on computer readable media. Computer readable media may be any available media that may be accessed by a computer. By way of example and not meant to be limiting, computer readable media may include “computer storage media” and “communications media.” “Computer storage media” may include volatile and non-volatile, removable and non-removable media implemented in any methods or technology for storage of information such as computer readable instructions, data structures, program modules, or other data. Exemplary computer storage media may include RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which may be used to store the desired information and which may be accessed by a computer.

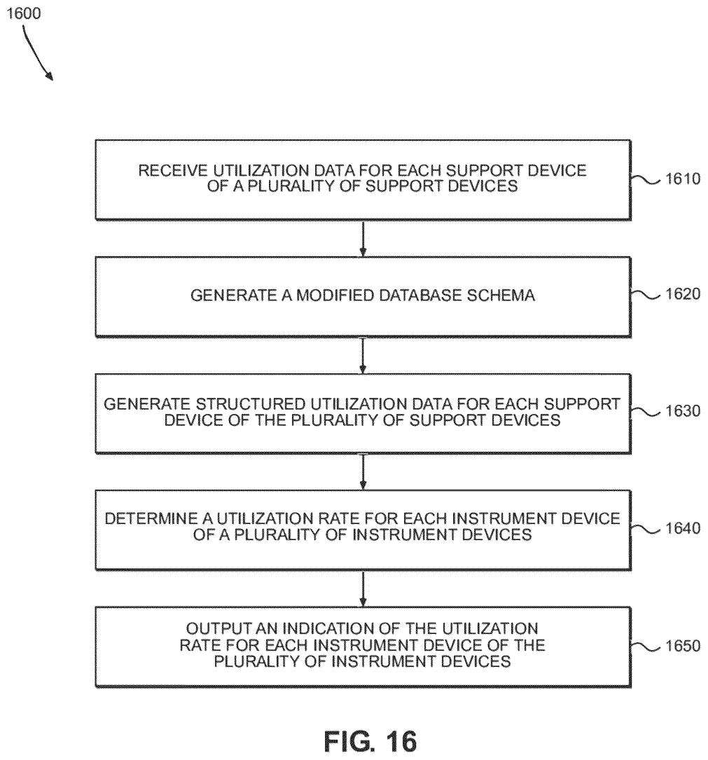

FIG. 16 shows a flowchart of an example method 1600 for improved instrument monitoring and analytics. The method 1600 may be performed in whole or in part by a single computing device, a plurality of computing devices, and the like. For example, the steps of the method 1600 may be performed by a computing device within or associated with the monitoring and analytics system 110 shown in FIG. 1 and/or a computing device in communication with any of the devices/entities of the system 100.

At step 1610, a computing device may receive utilization data (e.g., raw utilization data 111) for each support device of a plurality of support devices. Each support device of the plurality of support devices may be in communication with (e.g., communicably coupled to) at least one instrument device of a plurality of instrument devices. The plurality of support devices may receive input data from the plurality of instrument devices (e.g., the “input data” described herein).

The utilization data and/or the structured utilization data for each support device of the plurality of support devices may be based on the input data received from the plurality of instrument devices. For example, the utilization data and/or the structured utilization data may be associated with execution of at least one instrument application executing on each instrument device of the plurality of instrument devices. That is, the utilization data and/or the structured utilization data for each support device may be associated with that support device's control/operation of the corresponding instrument device as it collects and/or generates the corresponding input data. For example, the utilization data and/or the structured utilization data for each support device may be associated with that support device receiving, processing, and/or sending the input data (e.g., for storage of the input data at the monitoring and analytics system 110). The input data associated with a particular instrument device may be received by the corresponding support device via the at least one instrument application executing on the particular instrument device. For example, the support device may execute at least one support device application (e.g., support device application 107) that facilitates the support device operating/controlling the instrument device and receiving the corresponding input data.

At step 1620, the computing device may generate a modified database schema (e.g., the analytics schema 113). The modified database schema may include a plurality of fields (e.g., the “Name,” “Utilization Search Mechanism,” “Utilization Instrument Software Process,” “Utilization Resource Consumption Threshold,” “Utilization Time Binning,” and “Instrument ECN” fields described herein). For example, a database schema for a database associated with configuration data for the plurality of instrument devices and/or the plurality of support devices (e.g., the CMDB schema as described herein) may be modified by appending the plurality of fields to the database schema. The plurality of fields may be appended to database schema to facilitate querying the utilization data associated with a specific instrument device of the plurality of instrument devices (e.g., based on the “Instrument ECN” field).

At step 1630, the computing device may generate structured utilization data for each support device of the plurality of support devices. The computing device may generate the structured utilization data for each support device of the plurality of support devices based on the utilization data for each support device of the plurality of support devices and the modified database schema. For example, the structured utilization data may include the plurality of fields. The structured utilization data may be generated, in some examples, by a support device(s). For example, a first support device of the plurality of support devices may generate the structured utilization data associated with the first support device based on the utilization data associated with the first support device and/or the modified database schema. Additionally, or in the alternative, the database associated with the plurality of support devices may generate the structured utilization data based on the utilization data associated with each support device of the plurality of support devices and/or the modified database schema.

At step 1640, the computing device may determine a utilization rate for each instrument device of the plurality of instrument devices. For example, the computing device may determine the utilization rate for each instrument device based on at least one query associated with the structured utilization data for each support device of the plurality of support devices. The at least one query may include at least one field of the plurality of fields (e.g., the “Name,” “Utilization Search Mechanism,” “Utilization Instrument Software Process,” “Utilization Resource Consumption Threshold,” “Utilization Time Binning,” and/or “Instrument ECN” field described herein).

The at least one field may be associated with, or indicative of, processor usage of each support device of the plurality of support devices. Determining the utilization rate for each instrument device of the plurality of instrument devices may include determining that the processor usage, indicated by or associated with at least one field, meets or exceeds a configurable threshold value. The at least one field within the structured utilization data for each support device may be indicative of the processor usage for the corresponding support device. The configurable threshold value may be based on a processor usage associated with an idle state of the support device. Other examples are possible as well.

Additionally, or in the alternative, the at least one field may be associated with, or indicative of, memory usage of each support device of the plurality of support devices. Determining the utilization rate for each instrument device of the plurality of instrument devices may include determining that the memory usage, indicated by or associated with at least one field, meets or exceeds a configurable threshold value. The at least one field within the structured utilization data for each support device may be indicative of the memory usage for the corresponding support device. The configurable threshold value may be based on a memory usage associated with an idle state of the support device. At step 1650, the computing device may output an indication of the utilization rate for each instrument device of the plurality of instrument devices. For example, the computing device may output an indication of the utilization rate for each instrument via a graphical user interface, such as one or more of the dashboards described herein.

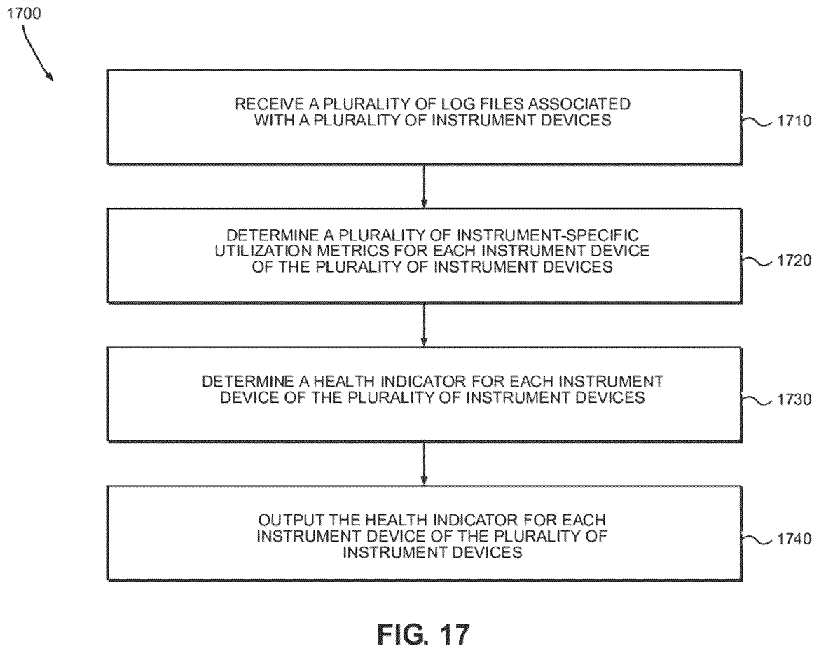

FIG. 17 shows a flowchart of an example method 1700 for improved instrument monitoring and analytics. The method 1700 may be performed in whole or in part by a single computing device, a plurality of computing devices, and the like. For example, the steps of the method 1700 may be performed by a computing device within or associated with the monitoring and analytics system 110 shown in FIG. 1 and/or a computing device in communication with any of the devices/entities of the system 100.

At step 1710, a computing device may receive a plurality of log files associated with a plurality of instrument devices. The computing device may receive the plurality of log files from a plurality of support device. Each support device of the plurality of support devices may be in communication with (e.g., communicably coupled to) at least one instrument device of the plurality of instrument devices. Each support device of the plurality of support devices may receive input data from the at least one instrument device corresponding to that support device. Each instrument device may execute at least one instrument application (e.g., the instrument application(s) 103). For example, each support device may operate/control the at least one instrument device to which that support device is communicably coupled via the at least one instrument application executing on that at least one instrument device. The input data associated with the at least one instrument device corresponding to a particular support device may be received via the at least one instrument application. For example, the support device may execute at least one support device application (e.g., support device application 107) that facilitates the support device operating/controlling the at least one instrument device and receiving the corresponding input data.

The plurality of support devices may receive the plurality of log files from the plurality of instrument devices (e.g., via the at least one instrument application and the at least one support device application). The plurality of log files may include, or be based on, a plurality of filtered verbose log files, which may be filtered to remove irrelevant information. For example, the plurality of filtered verbose log files may be based on a plurality of instrument-specific filters applied to the plurality of log files. The plurality of instrument-specific filters may include an instrument type, an instrument manufacturer, a type of experiment or study, a type of an instrument application, or a developer of the instrument application.

At step 1720, the computing device may determine a plurality of instrument-specific utilization metrics for each instrument device of the plurality of instrument devices. For example, the computing device may determine the plurality of instrument-specific utilization metrics based on the plurality of log files. In some examples, the plurality of support devices may send the plurality of log files to a monitoring and analytics system (e.g., the monitoring and analytics system 110), and the plurality of instrument-specific utilization metrics may be generated by the monitoring and analytics system. The instrument-specific utilization metrics may indicate a number of states for the corresponding instrument device. For example, the instrument-specific utilization metrics for a first instrument device of the plurality of instrument devices may include at least one of: an indication of a starting use time for the first instrument device, an indication of an ending use time for the first instrument device, an indication of one or more warnings associated with the first instrument device, an indication of one or more errors associated with the first instrument device, or an indication of one or more informational events associated with the first instrument device.

At step 1730, the computing device may determine a health indicator for each instrument device of the plurality of instrument devices. For example, the computing device may determine the health indicator for each instrument device based on the plurality of instrument-specific utilization metrics for each instrument device of the plurality of instrument devices. The health indicator may be indicative of an availability of the corresponding instrument device. For example, the health indicator for each instrument device may indicate whether that instrument device is associated with one of a plurality of “availability states.” For example, the health indicator for a first instrument device of the plurality of instrument devices may indicate the first instrument device is associated with an idle state, a running state, a less-than-critical error state, a critical error state, or an offline state

At step 1740, the computing device may output the health indicator for each instrument device of the plurality of instrument devices. For example, the computing device may output the health indicator for each instrument device of the plurality of instrument devices via a graphical user interface. The health indicator for each instrument device of the plurality of instrument devices may be indicative of an amount of time since that instrument device was associated with at least one error state. The computing device may determine when each instrument device of the plurality of instrument devices is no longer associated with the at least one error state. The computing device may output, via the graphical user interface, a refreshed health indicator for an instrument device when it is determined that the instrument device is no longer associated with the at least one error state. Other examples are possible as well.

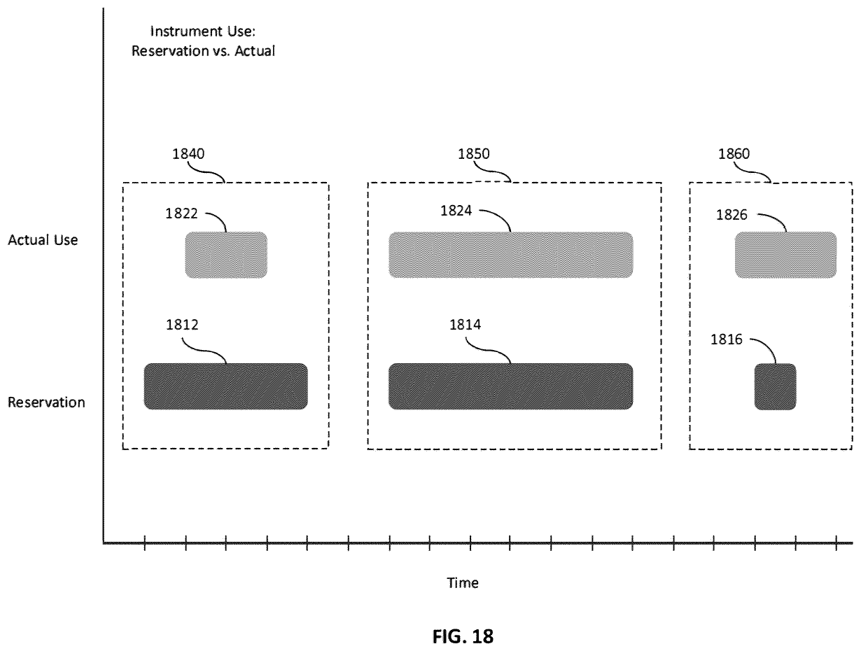

FIG. 18 illustrates an example comparison of reservation data that may be generated by system 100 and/or environment 1500 for an instrument device 102. FIG. 18 shows scheduled reservations vs. actual use of the instrument device 102. Such a comparison may allow for a more efficient use of an instrument device 102 by giving instrument device users and administrators an improved awareness of usage including overuse (where an instrument device 102 is used for longer than a reservation block) or underuse (where an instrument device 102 is reserved, but not in active use). For example, overuse information can be the basis for justifying buying additional instruments, while underuse information can be used to move the underused instrument device(s) to areas where utilization of that type of instrument device is higher.

A user may utilize support device 104, computing device 1501, or other suitable device to create reservation data 1810 (which may include both past, present, and future reservations) such as first reservation block 1812, second reservation block 1814, and/or third reservation block 1816. A user may select one or more blocks of time by clicking and dragging across a continuous group of blocks on a calendar or similar user interface. In some examples, the availability of a given instrument device and/or the location of an available instrument device may be made available to the user in a manner similar to that employed in Microsoft Outlook Room Finder (e.g., see https://learn.microsoft.com/en-us/outlook/troubleshoot/calendaring/configure-room-finder-rooms-workspaces).

Once a user has selected a time for a reservation block, the reservation block may be added to instrument device data 1528, structured utilization data 109, and/or raw utilization data 111 and stored in an appropriate location such as database 108, system memory 1510, one or more calendaring applications, or the like.

In an embodiment, support device 104, computing device 1501, and/or any suitable computing device in accordance with the present technology may utilize forwarding component 105, I/O interfaces 1512, and/or network interface 1514 to access reservation data. A suitable computing device may utilize an application programming interface (API) to store and retrieve reservation data and/or utilization data.

An exemplary instrument device 102 may be shared by a plurality of users who schedule instrument usage, for example using support device 104. Each user may select a block of time for using the instrument device 102, shown as first reservation block 1812, second reservation block 1814, and third reservation block 1816 in FIG. 18. The user then uses the instrument device 102 normally during their reserved block of time as depicted by first instrument usage 1822, second instrument usage 1824, and third instrument usage 1826. Usage data 1820 may be stored as part of structured utilization data 109 and/or raw utilization data 111. However, a duration of instrument usage may not always correspond to the associated reservation block.

Data related to usage and/or reservations of instrument device 102 may be stored in structured utilization data 109 and/or raw utilization data 111. For example, when a user creates a reservation block for instrument device 102, the reservation block and related information may be stored using structured utilization data 109.

For example, FIG. 18 illustrates a variety of instrument utilization states that represent instrument usage vs. reservation blocks. As a preliminary matter, it should be appreciated that, for purposes of the present discussion, the notion of “instrument usage” may involve one or more time periods beyond specific operation of the instrument (e.g., 10% or 15% longer than specific operation of the instrument). For example, before and/or after specific operation of the instrument, an operator of a given instrument may need a set-up time period and/or a break-down time period. Additionally or alternatively, the operator may require some amount of time running analytics on the support device for the instrument before or after specific operation of the instrument. Accordingly, “instrument usage” may include a tolerance factor that accounts for operator-required time during a reservation block that exceeds specific operation of a given instrument. It should be appreciated that, in some examples, such a tolerance factor may be specific to a particular instrument.

Underused state 1840 occurs when an instrument usage duration is shorter than a corresponding reservation block. In underused state 1840, a first user has submitted first reservation block 1812 for four blocks of time (e.g., four 15 minute blocks, four 1-hour blocks, four 1-day blocks, etc.); however, the first user only used the instrument device 102 for two of the four blocks of time, resulting in first instrument usage 1822 only being half the duration of first reservation block 1812. This may result in a state where one or more other users need to use instrument device 102, but instrument device 102 sits idle because the one or more other users believe the instrument device 102 is still in use by the first user. Underused states may result in a decreased efficiency when an instrument device 102 could be productively used, but isn't.

An instrument utilization state may be considered underused when an instrument usage duration is shorter than a corresponding reservation block by at least a threshold amount of time or percentage. For example, an instrument utilization state may be considered underused when an instrument usage duration is at least about 5% shorter, at least about 7% shorter, at least about 10% shorter, at least about 15% shorter, at least about 20% shorter, at least about 25% shorter, at least about 33% shorter, or any suitable percentage shorter than a corresponding reservation block. Additionally or alternatively, an instrument utilization state may be considered underused when an instrument usage duration is at least about 5 minutes shorter, 10 minutes shorter, 15 minutes shorter, 20 minutes shorter, 30 minutes shorter, 45 minutes shorter, 60 minutes shorter, 90 minutes shorter, two hours shorter, four hours shorter, eight hours shorter, 12 hours shorter, 24 hours shorter, 36 hours shorter, 2 days shorter, 3 days shorter, 4 days shorter, 5 days shorter, 7 days shorter, 10 days shorter, or any amount of time shorter than a corresponding reservation block.

A normally used state 1850 occurs when an instrument usage duration is substantially equal to, within a threshold amount of time of, or within a threshold percentage of a corresponding reservation block duration. For example, an instrument device 102 may be considered normally used when an instrument usage duration is within about 20%, within about 15%, within about 12%, within about 10%, within about 8%, within about 7%, within about 5%, within about 4%, within about 3%, within about 2%, within about 1%, or within any suitable percentage of a corresponding reservation block duration. FIG. 18 illustrates that second instrument usage 1824 has substantially the same duration as second reservation block 1814 (both are six blocks of time), and instrument device 102 may therefore be considered normally used during these blocks of time.

Overused state 1860 occurs when an instrument usage duration is longer than a corresponding reservation block. In overused state 1860, a first user has submitted third reservation block 1816 for one block of time (e.g., one 15 minute block, one 1-hour block, one 1-day block, etc.); however, the first user has used the instrument device 102 for nearly three blocks of time, resulting in first instrument usage 1822 being nearly three times the duration of third reservation block 1816. This may result in a state where one or more other users have reserved instrument device 102, but cannot begin their experiments or procedures because of the first user. This may be particularly disruptive to time-sensitive processes that require the use of instrument device 102 on a precise schedule.

An instrument utilization state may be considered overused when an instrument usage duration is longer than a corresponding reservation block by at least a threshold amount of time or percentage. For example, an instrument utilization state may be considered overused when an instrument usage duration is at least about 5% longer, at least about 7% longer, at least about 10% longer, at least about 15% longer, at least about 20% longer, at least about 25% longer, at least about 33% longer, or any suitable percentage longer than a corresponding reservation block. Additionally or alternatively, an instrument utilization state may be considered overused when an instrument usage duration is at least about 5 minutes longer, 10 minutes longer, 15 minutes longer, 20 minutes longer, 30 minutes longer, 45 minutes longer, 60 minutes longer, 90 minutes longer, two hours longer, four hours longer, eight hours longer, 12 hours longer, 24 hours longer, 36 hours longer, 2 days longer, 3 days longer, 4 days longer, 5 days longer, 7 days longer, 10 days longer, or any amount of time longer than a corresponding reservation block.

Instrument device data 1528, structured utilization data 109, and/or raw utilization data 111 may include an operational status for instrument device 102. Operational statuses may include available, reserved and in use, reserved but not in use, in use but not reserved, and unavailable.

An operational status of available may indicate that instrument device 102 is not reserved, not being currently used, and is functioning properly.

An operational status of reserved and in use may indicate that instrument device 102 is reserved by a user, in use by that (or another) user, and is functioning properly.

An operational status of reserved but not in use may indicate that instrument device 102 has been reserved by a user and is functional, but is not being actively used. This may occur when a user has finished with the instrument earlier than the end of their reservation block, if a user is late to the start of their reservation, if the user did not show up for their reservation, or for a similar reason.

An operational status of in use but not reserved may indicate that an instrument device 102 is being actively used by a user even though that user does not have a reservation during that time. This may occur when a user has a rudimentary or short use for the instrument device 102, if an experiment or other use for instrument device 102 takes longer than a user anticipates, when a user forgets, neglects, or refuses to make a reservation for the instrument device 102, when a user was delayed from starting on time or otherwise disrupted, or other similar reasons.

An operational status of unavailable may indicate that the instrument device 102 is not available for use or reservation, for example if the instrument device 102 is not functioning due to repairs.

Support device 104, computing device 1501, or other suitable device may retrieve structured utilization data 109 and/or raw utilization data 111 (e.g., from database 108) in order to identify usage trends (e.g., if an instrument device 102 is overused more often in the afternoon than in the morning, if the instrument device 102 is overused on certain days of the week, etc.), instances of overuse or underuse, users associated with overuse or underuse (e.g., if a user is associated with more than a threshold number of instances of instrument overuse), or other usage metrics.

Reservation data 1810 and usage data 1820 for an instrument device 102 may be displayed via one or more I/O interfaces 1512. For example, computing device 1501 may retrieve reservation data 1810 and usage data 1820 and display the data in a format such as that illustrated in FIG. 18, including both reservation blocks and usage blocks and color-coding of information based on user, instrument, time of day, duration of block, laboratory, location, and the like. In an embodiment, computing device 1501 may display either reservation data 1810 or usage data 1820. User information associated with reservation data 1810 and/or usage data 1820 may be displayed as well. For example, a reservation block may include the name of the user who created the reservation block. Displayed reservation and usage data may further include an operational status of an instrument device 102, such as “Available,” “Reserved and In Use,” “Reserved But Not In Use,” “In Use,” “Unavailable,” etc.

Operating system 1518 of computing device 1501 may further include a messaging functionality through which users and/or administrators may send messages to one another, and in particular to users with reservations. A messaging functionality may include selecting a user to send a message to, one or more text fields for entering a message, one or more dropdown menus for selecting a predetermined message to send to a user, or the like. A messaging functionality may include a request for a second user to use a portion of a first user's reservation block, an inquiry regarding whether a first user intends to use the entirety of their reservation block, or other suitable functionality. A first user may message a second user about a past, present, or future reservation block, about a current usage of instrument device 102, about shifting or otherwise altering a reservation block, or the like.

A messaging functionality may be included in a display of one or more I/O interfaces 1512. For example, a first user may click on first reservation block 1812, and I/O interface 1512 may show the first user the name of the user who made first reservation block 1812 and present an option to message that user. This may allow the first user to more efficiently select their own reservation block, for example, if the second user indicates that they will not be needing to use instrument device 102 for their entire reservation.

### Example Method

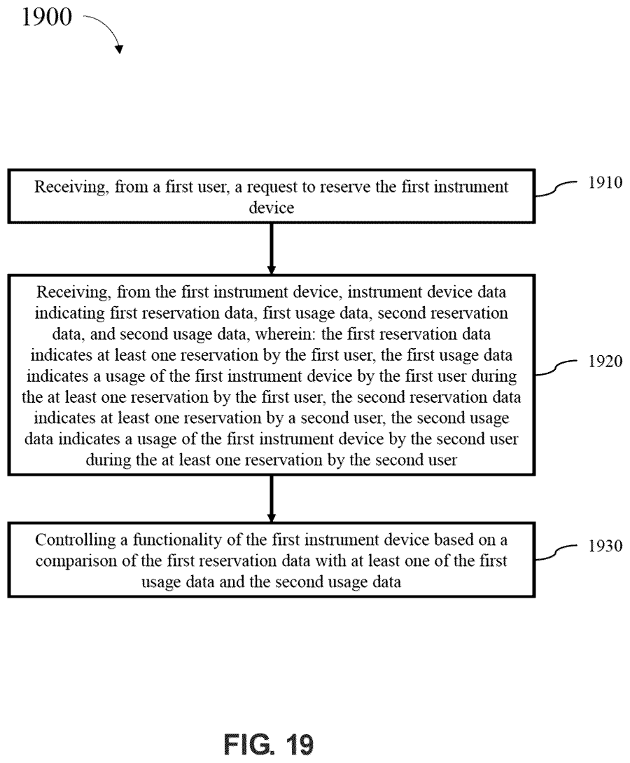

FIG. 19 is a flowchart of an example method 1900 for managing access to a first instrument device. Method 1900 includes blocks 1910-1930.

Block 1910 includes receiving, from a first user, a request to reserve the first instrument device.

Block 1920 includes receiving, from the first instrument device, instrument device data indicating first reservation data, first usage data, second reservation data, and second usage data. The first reservation data indicates at least one reservation by the first user; the first usage data indicates a usage of the first instrument device by the first user during the at least one reservation by the first user; the second reservation data indicates at least one reservation by a second user; and the second usage data indicates a usage of the first instrument device by the second user during the at least one reservation by the second user.

The second usage data may indicate a plurality of instrument usage durations by the second user and the second reservation data may indicate a corresponding plurality of instrument reservation durations by the second user. If each of the instrument usage durations by the second user are less than a threshold longer than the plurality of instrument reservation durations by the second user, a functionality of the first instrument device may be enabled for the first user.

The second usage data may indicate a plurality of instrument usage durations by the second user and the second reservation data may indicate a corresponding plurality of instrument reservation durations by the second user. If each of the instrument usage durations by the second user are more than a threshold shorter than the plurality of instrument reservation durations by the second user, a functionality of the first instrument device may be enabled for the first user.

If the first usage data includes a plurality of usage durations by the first user that exceed a corresponding plurality of reservation durations, by the first user and indicated by third reservation data, by more than a threshold, a functionality of the first instrument device may be disabled for the first user. The third reservation data may include the corresponding plurality of reservation durations.

Block 1930 includes controlling a functionality of the first instrument device based on a comparison of the first reservation data with at least one of the first usage data and the second usage data. A functionality of the first instrument device for the first user may be disabled based on an operational status of the first instrument device indicated by the second usage data. A functionality of the first instrument device may be disabled for the first user in response to the second usage data indicating that an operational status of the first instrument device is unavailable. A notification may be transmitted to the first user in response to the second reservation data and the second usage data differing by more than a threshold. A notification may be transmitted to the first user in response to the second usage data indicating that the usage of the first instrument device by the second user has ended prior to the at least one reservation of the second user.

### CONCLUSION

While specific configurations have been described, it is not intended that the scope be limited to the particular configurations set forth, as the configurations herein are intended in all respects to be possible configurations rather than restrictive.

Unless otherwise expressly stated, it is in no way intended that any method set forth herein be construed as requiring that its steps be performed in a specific order. Accordingly where a method claim does not actually recite an order to be followed by its steps or it is not otherwise specifically stated in the claims or descriptions that the steps are to be limited to a specific order, it is in no way intended that an order be inferred, in any respect. This holds for any possible non-express basis for interpretation, including: matters of logic with respect to arrangement of steps or operational flow; plain meaning derived from grammatical organization or punctuation; the number or type of configurations described in the specification.

While various inventive embodiments have been described and illustrated herein, those of ordinary skill in the art will readily envision a variety of other means and/or structures for performing the function and/or obtaining the results and/or one or more of the advantages described herein, and each of such variations and/or modifications is deemed to be within the scope of the inventive embodiments described herein. More generally, those skilled in the art will readily appreciate that all parameters, dimensions, materials, and configurations described herein are meant to be exemplary and that the actual parameters, dimensions, materials, and/or configurations will depend upon the specific application or applications for which the inventive teachings is/are used. Those skilled in the art will recognize, or be able to ascertain using no more than routine experimentation, many equivalents to the specific inventive embodiments described herein. It is, therefore, to be understood that the foregoing embodiments are presented by way of example only and that, within the scope of the appended claims and equivalents thereto, inventive embodiments may be practiced otherwise than as specifically described and claimed. Inventive embodiments of the present disclosure are directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the inventive scope of the present disclosure.

Also, various inventive concepts may be embodied as one or more methods, of which an example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

All definitions, as defined and used herein, should be understood to control over dictionary definitions, definitions in documents incorporated by reference, and/or ordinary meanings of the defined terms.

The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of” “Consisting essentially of,” when used in the claims, shall have its ordinary meaning as used in the field of patent law.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures, Section 2111.03.

1. A system for managing access to a first instrument device, the system comprising:
a plurality of support devices, each support device of the plurality of support devices communicatively coupled to a corresponding instrument device of a plurality of instrument devices;
a processor; and
a memory, the memory containing instructions thereon configuring the processor to:
receive, from the plurality of support devices, utilization data for each support device of the plurality of support devices and each instrument device of the plurality of instrument devices, wherein the utilization data is associated with execution of at least one instrument application on each instrument device of the plurality of instrument devices, and wherein each support device controls operation of the instrument device to which that support device is communicably coupled via the at least one instrument application executing on that instrument device;
receive, from each support device, scheduling information and operational information for the instrument device communicatively coupled to that support device, the operational information indicating whether that instrument device is available for use, reserved and in use, reserved but not in use, in use but not reserved, or unavailable for use;
generate structured utilization data for each support device of the plurality of support devices and each instrument device of the plurality of instrument devices, wherein the structured utilization data comprises a plurality of fields; and
compare the at least one of the utilization data or the structured utilization data for each instrument device to its corresponding operational information over a predetermined time period or a predetermined time duration to classify usage of that instrument device as underused, overused, or normal.

2. The system of claim 1, wherein the instructions further configure the processor to:
receive, from a first user, a request to reserve the first instrument device;
receive, from the first instrument device, structured utilization data for the first instrument device indicating first reservation data, first usage data, second reservation data, and second usage data, wherein:
the first reservation data indicates at least one reservation by the first user;
the first usage data indicates a usage of the first instrument device by the first user during the at least one reservation by the first user;
the second reservation data indicates at least one reservation by a second user;
the second usage data indicates a usage of the first instrument device by the second user during the at least one reservation by the second user;
controlling a functionality of the first instrument device based on a comparison of the first reservation data with at least one of the first usage data and the second usage data.

3. The system of claim 2, wherein the second usage data indicates a plurality of instrument usage durations by the second user and the second reservation data indicates a corresponding plurality of instrument reservation durations by the second user;
each of the instrument usage durations by the second user are less than a threshold longer than the plurality of instrument reservation durations by the second user; and
enabling a functionality of the first instrument device for the first user in response to the second usage data and the second reservation data differing by less than a threshold.

4. The system of claim 2, wherein the second usage data indicates a plurality of instrument usage durations by the second user and the second reservation data indicates a corresponding plurality of instrument reservation durations by the second user;
each of the instrument usage durations by the second user are more than a threshold shorter than the plurality of instrument reservation durations by the second user; and
enabling a functionality of the first instrument device for the first user in response to the second usage data and the second reservation data differing by more than a threshold.

5. A method for managing access to a first instrument device, the method comprising:
receiving, from a first user, a request to reserve the first instrument device;
receiving instrument device data indicating first reservation data, first usage data, second reservation data, and second usage data, wherein:
the first reservation data indicates at least one reservation by the first user;
the first usage data indicates a usage of the first instrument device by the first user during the at least one reservation by the first user;
the second reservation data indicates at least one reservation by a second user;
the second usage data indicates a usage of the first instrument device by the second user during the at least one reservation by the second user;
controlling a functionality of the first instrument device based on a comparison of the first reservation data with at least one of the first usage data and the second usage data.

6. The method of claim 5, wherein the second usage data indicates a plurality of instrument usage durations by the second user and the second reservation data indicates a corresponding plurality of instrument reservation durations by the second user;
each of the instrument usage durations by the second user are less than a threshold longer than the plurality of instrument reservation durations by the second user; and
enabling a functionality of the first instrument device for the first user in response to the second usage data and the second reservation data differing by less than a threshold.

7. The method of claim 5, wherein the second usage data indicates a plurality of instrument usage durations by the second user and the second reservation data indicates a corresponding plurality of instrument reservation durations by the second user;
each of the instrument usage durations by the second user are more than a threshold shorter than the plurality of instrument reservation durations by the second user; and
enabling a functionality of the first instrument device for the first user in response to the second usage data and the second reservation data differing by more than a threshold.

8. The method of claim 5, further comprising:
disabling a functionality of the first instrument device for the first user in response to the first usage data comprising a plurality of usage durations by the first user that exceed a corresponding plurality of reservation durations, by the first user and indicated by third reservation data, by more than a threshold;
wherein the third reservation data comprises the corresponding plurality of reservation durations.

9. The method of claim 5, further comprising:
disabling a functionality of the first instrument device for the first user based on an operational status of the first instrument device indicated by the second usage data.

10. The method of claim 9, further comprising:
disabling a functionality of the first instrument device for the first user in response to the second usage data indicating that an operational status of the first instrument device is unavailable.

11. The method of claim 5, further comprising:
transmitting a notification to the first user in response to the second reservation data and the second usage data differing by more than a threshold.

12. The method of claim 5, further comprising:
transmitting a notification to the first user in response to the second usage data indicating that the usage of the first instrument device by the second user has ended prior to the at least one reservation of the second user.

13. A non-transitory computer readable medium having instructions stored thereon, the instructions configuring a processor to perform a method for managing access to a first instrument device, the method comprising:
receiving, from a first user, a request to reserve the first instrument device;
receiving, from the first instrument device, instrument device data indicating first reservation data, first usage data, second reservation data, and second usage data, wherein:
the first reservation data indicates at least one reservation by the first user;
the first usage data indicates a usage of the first instrument device by the first user during the at least one reservation by the first user;
the second reservation data indicates at least one reservation by a second user;
the second usage data indicates a usage of the first instrument device by the second user during the at least one reservation by the second user;
controlling a functionality of the first instrument device based on a comparison of the first reservation data with at least one of the first usage data and the second usage data.

14. The medium of claim 13, wherein the second usage data indicates a plurality of instrument usage durations by the second user and the second reservation data indicates a corresponding plurality of instrument reservation durations by the second user;
each of the instrument usage durations by the second user are less than a threshold longer than the plurality of instrument reservation durations by the second user; and
enabling a functionality of the first instrument device for the first user in response to the instrument usage durations by the second user being longer than the plurality of instrument reservation durations by the second user by less than a threshold.

15. The medium of claim 13, wherein the second usage data indicates a plurality of instrument usage durations by the second user and the second reservation data indicates a corresponding plurality of instrument reservation durations by the second user;
each of the instrument usage durations by the second user are more than a threshold shorter than the plurality of instrument reservation durations by the second user; and
enabling a functionality of the first instrument device for the first user in response to the instrument usage durations by the second user being shorter than the plurality of instrument reservation durations by the second user by more than a threshold.

16. The medium of claim 13, the method further comprising:
disabling a functionality of the first instrument device for the first user in response to the first usage data comprising a plurality of usage durations by the first user that exceed a corresponding plurality of reservation durations, by the first user and indicated by third reservation data, by more than a threshold;
wherein the third reservation data comprises the corresponding plurality of reservation durations.

17. The medium of claim 13, the method further comprising:
disabling a functionality of the first instrument device for the first user based on an operational status of the first instrument device indicated by the second usage data.

18. The medium of claim 17, the method further comprising:
disabling a functionality of the first instrument device for the first user in response to the second usage data indicating that an operational status of the first instrument device is unavailable.

19. The medium of claim 13, the method further comprising:
transmitting a notification to the first user in response to the second reservation data and the second usage data differing by more than a threshold.

20. The medium of claim 13, the method further comprising:
transmitting a notification to the first user in response to the second usage data indicating that the usage of the first instrument device by the second user has ended prior to the at least one reservation of the second user.
